(19) United States
(12) Patent Application Publication
(10) Pub. No.: US 2022/0057146 A1
(43) Pub. Date: Feb. 24, 2022

(54) TOTAL HEAT EXCHANGE ELEMENT

(71) Applicant: DAIKIN INDUSTRIES, LTD., Osaka (JP)

(72) Inventors: Takema NAKAZAWA, Osaka (JP); Masaya KASAI, Osaka (JP)

(21) Appl. No.: 17/521,317

(22) Filed: Nov. 8, 2021

Related U.S. Application Data
(63) Continuation of application No. PCT/JP2020/017121, filed on Apr. 21, 2020.

(30) Foreign Application Priority Data
May 9, 2019 (JP) 2019-088844

(51) Int. Cl. F28D 15/04

(52) U.S. Cl. CPC F28D 15/04

(57) ABSTRACT

A total heat exchange element includes a plurality of partition plates arranged at intervals. Each of the partition plates includes a base having a first principal surface and a second principal surface, and a moisture permeable membrane provided on or close to the first principal surface of the base. First flow paths through which air flows and second flow paths through which air having a higher water vapor pressure than the air in the first flow paths flows are alternately arranged with an associated one of the partition plates sandwiched between adjacent ones of the first flow paths and the second flow paths. In each of the plurality of partition plates, the first principal surface of the base faces a corresponding one of the first flow paths, and the second principal surface of the base faces a corresponding one of the second flow paths.

### CROSS-REFERENCE TO RELATED APPLICATIONS

This is a continuation of International Application No. PCT/JP2020/017121 filed on Apr. 21, 2020, which claims priority to Japanese Patent Application No. 2019-088844, filed on May 9, 2019. The entire disclosures of these applications are incorporated by reference herein.

### BACKGROUND

### Field of Invention

The present disclosure relates to a total heat exchange element.

### Background Information

A total heat exchange element having a partition plate including a base layer and a moisture permeable membrane layer provided on the base layer has been known (see, e.g., Japanese Patent No. 5230821). This total heat exchange element having the partition plate including the base layer and the moisture permeable membrane layer solves a problem of condensed water that drips when the element is used in a high-humidity environment.

### SUMMARY

A first aspect of the present disclosure is directed to a total heat exchange element including a plurality of partition plates arranged at intervals. Each of the partition plates includes a base having a first principal surface and a second principal surface, and a moisture permeable membrane provided on or close to the first principal surface of the base. First flow paths through which air flows and second flow paths through which air having a higher water vapor pressure than the air in the first flow paths flows are alternately arranged with an associated one of the partition plates sandwiched between adjacent ones of the first flow paths and the second flow paths. In each of the plurality of partition plates, the first principal surface of the base faces a corresponding one of the first flow paths, and the second principal surface of the base faces a corresponding one of the second flow paths.

### BRIEF DESCRIPTION OF THE DRAWINGS

FIG. 1 is a schematic diagram illustrating a ventilation device including a total heat exchange element according to an embodiment.

FIG. 2 is a schematic perspective view illustrating the total heat exchange element according to the embodiment.

FIG. 3 is a cross-sectional view illustrating an essential portion of the total heat exchange element according to the embodiment.

FIG. 4 is a cross-sectional view illustrating an essential portion of a total heat exchange element according to another embodiment.

### DETAILED DESCRIPTION OF EMBODIMENT(S)

A total heat exchange element (30) according to an embodiment will be described below.

Ventilation Device

The total heat exchange element (30) according to this embodiment is provided for a ventilation device (10). The ventilation device (10) including the total heat exchange element (30) will be described below.

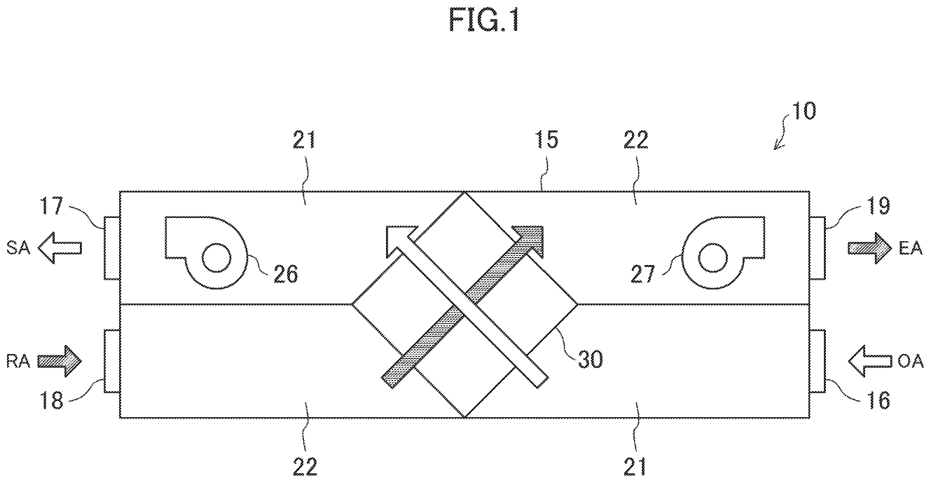

As illustrated in FIG. 1, the ventilation device (10) includes a casing (15) that houses the total heat exchange element (30). The casing (15) includes an outdoor air inlet (16), an air supply port (17), an indoor air inlet (18), and an exhaust port (19). An air supply passage (21) and an exhaust passage (22) are formed in an internal space of the casing (15). The air supply passage (21) has an end connected to the outdoor air inlet (16). The other end of the air supply passage (21) is connected to the air supply port (17). The exhaust passage (22) has an end connected to the indoor air inlet (18). The other end of the exhaust passage (22) is connected to the exhaust port (19).

The total heat exchange element (30) is arranged to cross the air supply passage (21) and the exhaust passage (22). The total heat exchange element (30) is disposed in the casing (15) such that first air flow paths (36) to be described later communicate with the air supply passage (21), and second air flow paths (37) to be described later communicate with the exhaust passage (22). The total heat exchange element (30) will be described in detail later.

The ventilation device (10) further includes an air supply fan (26) and an exhaust fan (27). The air supply fan (26) is disposed downstream of the total heat exchange element (30) in the air supply passage (21) (i.e., near the air supply port (17)). The exhaust fan (27) is disposed downstream of the total heat exchange element (30) in the exhaust passage (22) (i.e., near the exhaust port (19)).

In the ventilation device (10), outdoor air flows through the air supply passage (21) toward the inside of the room, and indoor air flows through the exhaust passage (22) toward the outside of the room. The total heat exchange element (30) exchanges sensible heat and moisture (latent heat) between the outdoor air flowing through the air supply passage (21) and the indoor air flowing through the exhaust passage (22).

Total Heat Exchange Element

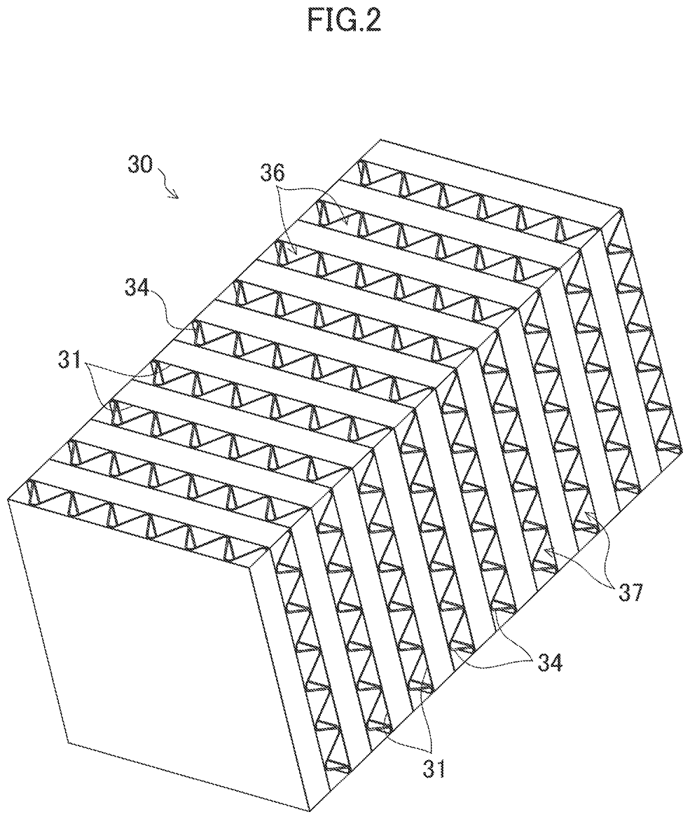

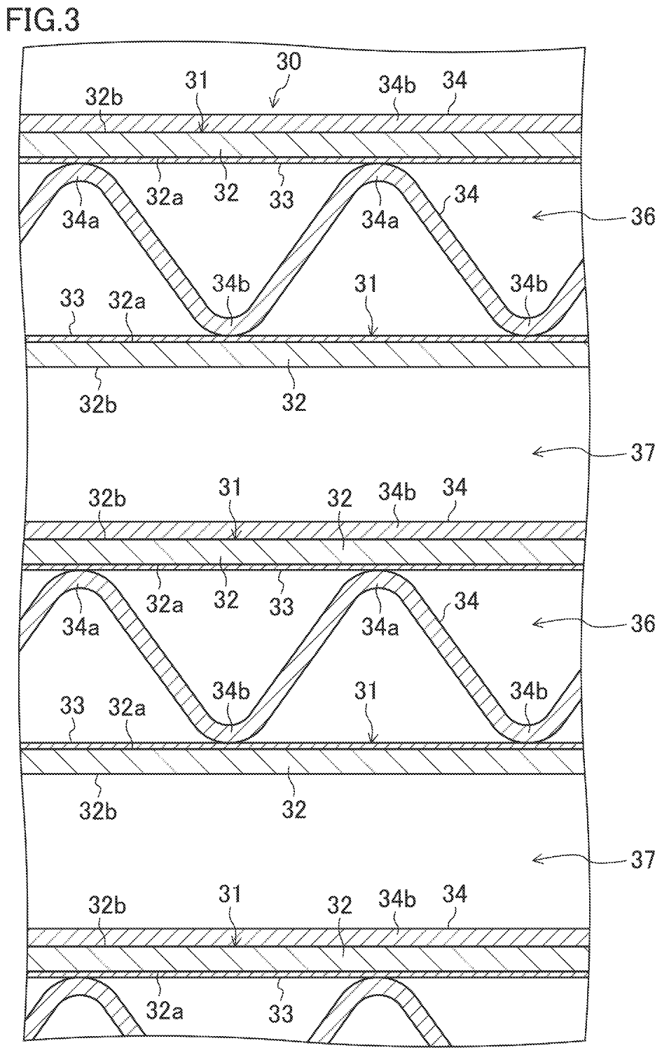

As illustrated in FIGS. 2 and 3, the total heat exchange element (30) is a cross-flow heat exchanger having the first air flow paths (36) and the second air flow paths (37). The total heat exchange element (30) includes a plurality of partition plates (31) and a plurality of spacing members (34) which are alternately stacked to form a quadrangular prism as a whole.

In the total heat exchange element (30), a distance between each adjacent pair of the partition plates (31) is substantially kept constant by an associated one of the spacing members (34).

The partition plates (31) are configured as flat sheet shaped (sheet-like) members that are generally square in plan view. Each of the partition plates (31) has a porous base (32) and a moisture permeable membrane (33). The partition plate (31) has a thickness of 30 μm or less, but is not limited to have this thickness.

The porous base (32) is a plate-shaped member having a first principal surface (32a) and a second principal surface (32b). The material of the porous base (32) is, for example, a nonwoven fabric of resin, metal, glass, or pulp, or a film of resin or metal. The porous base (32) has a thickness of several tens of but is not limited to have this thickness. The porous base (32) is permeable to moisture. The porous base (32) constitutes a base.

The moisture permeable membrane (33) is a sheet-like member provided on the first principal surface (32a) of the porous base (32). The moisture permeable membrane (33) covers the first principal surface (32a) of the porous base (32). No moisture permeable membrane (33) is provided on the second principal surface (32b) of the porous base (32). The moisture permeable membrane (33) is made of a polymer material containing a hydrophilic group and a hydrophobic group, e.g., polyurethane. The moisture permeable membrane (33) has a thickness of 1 μm or less, but is not limited to have this thickness. An exposed surface of the moisture permeable membrane (33), i.e., a surface facing the first air flow path (36), is different in color from the second principal surface (32b) of the porous base (32).

The spacing members (34) are configured as corrugated plate-shaped members that are generally square in plan view. Each of the spacing members (34) has a plurality of ridges (34a) each having linear ridge lines, and a plurality of valleys (34b) each having linear bottom lines. The ridge lines of the ridges (34a) and the bottom lines of the valleys (34b) are substantially parallel to each other. Each of the spacing members (34) has the ridges (34a) and the valleys (34b) alternately formed. Each of the spacing members (34) maintains the distance between the partition plates (31) arranged on both sides of the spacing member (34).

In the total heat exchange element (30), the first air flow paths (36) and the second air flow paths (37) are alternately formed in the stacking direction of the partition plates (31) and the spacing members (34), i.e., the direction of the center axis of the total heat exchange element (30). Each of the partition plates (31) separates an adjacent pair of the first air flow path (36) and the second air flow path (37) from each other. The first air flow paths (36) constitute first flow paths, and the second air flow paths (37) constitute second flow paths.

In the total heat exchange element (30), adjacent ones of the spacing members (34) with an associated one of the partition plates (31) interposed therebetween are arranged such that the direction of the ridge lines of one of the spacing members (34) are substantially orthogonal to the direction of the ridge lines of the other spacing member (34). This arrangement provides the total heat exchange element (30) with the first air flow paths (36) that open in a pair of opposed side surfaces of the total heat exchange element (30), and the second air flow paths (37) that open in the other pair of opposed side surfaces.

As illustrated in FIG. 3, each of the partition plates (31) is arranged such that the first principal surface (32a) provided with the moisture permeable membrane (33) faces the corresponding first air flow path (36). In other words, each of the partition plates (31) is arranged such that the second principal surface (32b) provided with no moisture permeable membrane (33) faces the corresponding second air flow path (37). The partition plates (31) adjacent to each other across the first air flow path (36) have the first principal surfaces (32a) facing each other. The partition plates (31) adjacent to each other across the second air flow path (37) have the second principal surfaces (32b) facing each other.

Arrangement of Total Heat Exchange Element

For example, consider a state in which the indoor air has a lower water vapor pressure than the outdoor air, like in summer. In such a state, the total heat exchange element (30) is arranged such that the second air flow paths (37) communicate with the air supply passage (21), and the first air flow paths (36) communicate with the exhaust passage (22). Thus, the second principal surface (32b) of the porous base (32) is arranged to face the second air flow path (37) communicating with the air supply passage (21) through which the outdoor air having a higher water vapor pressure than the air in the exhaust passage (22) flows, and the first principal surface (32a) of the porous base (32) is arranged to face the first air flow path (36) communicating with the exhaust passage (22) through which the indoor air having a lower water vapor pressure than the air in the air supply passage (21) flows.

Then, consider a state in which the outdoor air has a lower water vapor pressure than the indoor air, like in winter, for example. In such a state, the total heat exchange element (30) is arranged such that the first air flow paths (36) communicate with the air supply passage (21) and the second air flow paths (37) communicate with the exhaust passage (22). Thus, the first principal surface (32a) of the porous base (32) faces the first air flow path (36) communicating with the air supply passage (21) through which the outdoor air having a lower water vapor pressure than the air in the exhaust passage (22) flows, and the second principal surface (32b) of the porous base (32) faces the second air flow path (37) communicating with the exhaust passage (22) through which the indoor air having a higher water vapor pressure than the air in the air supply passage (21) flows.

As described above, the air flows through the first air flow path (36) of the total heat exchange element (30), and the air having a higher water vapor pressure than the air in the first air flow path (36) flows through the second air flow path (37) of the total heat exchange element (30). In other words, the total heat exchange element (30) of this embodiment is used with the air having a lower water vapor pressure than the air in the second air flow path (37) flowing through the first air flow path (36), and the air having a higher water vapor pressure than the air in the first air flow path (36) flowing through the second air flow path (37).

### Advantages of Embodiment

The total heat exchange element (30) of the present embodiment includes: a plurality of partition plates (31) arranged at intervals, each of the partition plates (31) including a porous base (32) having a first principal surface (32a) and a second principal surface (32b), and a moisture permeable membrane (33) provided on or close to the first principal surface (32a) of the porous base (32), wherein first air flow paths (36) through which air flows and second air flow paths (37) through which air having a higher water vapor pressure than the air in the first air flow paths (36) flows are alternately arranged with an associated one of the partition plates (31) sandwiched between adjacent ones of the first air flow paths (36) and the second air flow paths (37), and in each of the plurality of partition plates (31), the first principal surface (32a) of the base (32) faces a corresponding one of the first air flow paths (36), and the second principal surface (32b) of the base (32) faces a corresponding one of the second air flow paths (37). The above findings are applied to the total heat exchange element (30). The first air flow paths (36) and the second air flow paths (37) are alternately arranged with an associated one of the partition plates (31) sandwiched therebetween, and each of the partition plates (31) is arranged with the first principal surface (32a) facing a corresponding one of the first air flow paths (36), and the second principal surface (32b) facing a corresponding one of the second air flow paths (37). This can maximize the amount of moisture moving through the partition plate (31) having the porous base (32) and the moisture permeable membrane (33) when the water vapor pressure is higher in the second air flow path (37) than in the first air flow path (36), and thus, the partition plate (31) can be effectively used.

The total heat exchange element (30) of the present embodiment includes the moisture permeable membrane (33) provided on the first principal surface (32a) of the porous base (32). Thus, the partition plate (31) having the porous base (32) and the moisture permeable membrane (33) can be easily manufactured.

In the total heat exchange element (30) of the present embodiment, at least a portion of the moisture permeable membrane (33) is exposed from the first principal surface (32a) of the porous base (32), and an exposed surface of the moisture permeable membrane (33) is different in color from the second principal surface (32b) of the porous base (32). Thus, the surface of the partition plate (31) on which the moisture permeable membrane (33) is provided and the surface of the partition plate (31) on which no moisture permeable membrane (33) is provided can be visually distinguished from each other. This can reduce errors during assembly of the total heat exchange element (30).

The method of using the total heat exchange element (30) of the present embodiment includes using the total heat exchange element (30) with the air flowing through the first air flow paths (36) and the air having a higher water vapor pressure than the air in the first air flow paths (36) flowing through the second air flow paths (37). The above findings are applied to this method. The total heat exchange element (30) is used with the first principal surface (32a) facing the first air flow path (36) through which the air having a lower water vapor pressure than the air in the second air flow path (37) flows, and the second principal surface (32b) facing the second air flow path (37) through which the air having a higher water vapor pressure than the air in the first air flow path (36) flows. This can maximize the amount of moisture moving through the partition plate (31) having the porous base (32) and the moisture permeable membrane (33) when the water vapor pressure is higher in the second air flow path (37) than in the first air flow path (36), and thus, the partition plate (31) can be effectively used.

### OTHER EMBODIMENTS

The foregoing embodiment may also be configured as follows.

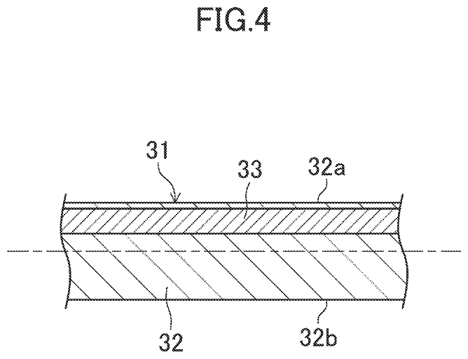

For example, as illustrated in FIG. 4, the moisture permeable membrane (33) may be provided in the porous base (32). In this example, the moisture permeable membrane (33) is provided in the porous base (32) near the first principal surface (32a). Specifically, the moisture permeable membrane (33) is provided in the porous base (32) to be located closer to the first principal surface (32a) than an intermediate plane indicated by a dot-dash line in FIG. 4 between the first principal surface (32a) and the second principal surface (32b).

For example, the total heat exchange element (30) may be an optional total heat exchange element other than the cross-flow total heat exchange element, such as a counterflow total heat exchange element.

For example, in the method of using the total heat exchange element (30), the total heat exchange element (30) may not be used with the air having a lower water vapor pressure than the air in the second air flow path (37) flowing through the first air flow path (36), and the air having a higher water vapor pressure than the air in the first air flow path (36) flowing through the second air flow path (37). It is only required that the total heat exchange element (30) is used in the same state for any optional period. For example, the total heat exchange element (30) may be intermittently used in the same state, or the total heat exchange element (30) may be used in the same state only at a specific time. The arrangement of the total heat exchange element (30) of the above embodiment is changed according to the season. However, a method of using the total heat exchange element (30) in the same state at any timing without changing the arrangement of the total heat exchange element (30) may also be included in the scope of the present disclosure.

While the embodiment and the variations thereof have been described above, it will be understood that various changes in form and details may be made without departing from the spirit and scope of the claims. The foregoing embodiment and the variations thereof may be combined and replaced with each other without deteriorating the intended functions of the present disclosure.

As can be seen from the foregoing description, the present disclosure is useful for a total heat exchange element.

1. A total heat exchange element comprising:
a plurality of partition plates arranged at intervals, each of the partition plates including a base having a first principal surface and a second principal surface, and a moisture permeable membrane provided on or close to the first principal surface of the base, wherein
first flow paths through which air flows and second flow paths through which air having a higher water vapor pressure than the air in the first flow paths flows being alternately arranged with an associated one of the partition plates sandwiched between adjacent ones of the first flow paths and the second flow paths, and
in each of the plurality of partition plates, the first principal surface of the base facing a corresponding one of the first flow paths, and the second principal surface of the base facing a corresponding one of the second flow paths.

2. The total heat exchange element of claim 1, wherein
the moisture permeable membrane is provided on the first principal surface of each base.

3. The total heat exchange element of claim 1, wherein
at least a portion of the moisture permeable membrane is exposed from the first principal surface of the base, and
an exposed surface of the moisture permeable membrane is different in color from the second principal surface of the base.

4. The total heat exchange element of claim 2, wherein
at least a portion of the moisture permeable membrane is exposed from the first principal surface of the base, and
an exposed surface of the moisture permeable membrane is different in color from the second principal surface of the base.

5. A method of using a total heat exchange element, the total heat exchange element including a plurality of partition plates arranged at intervals, each of the partition plates including a base having a first principal surface and a second principal surface, and a moisture permeable membrane provided on or close to the first principal surface of the base, first flow paths through which air flows and second flow paths through which air having a higher water vapor pressure than the air in the first flow paths flows being alternately arranged with an associated one of the partition plates sandwiched between adjacent ones of the first flow paths and the second flow paths, and in each of the plurality of partition plates, the first principal surface of the base facing a corresponding one of the first flow paths, and the second principal surface of the base facing a corresponding one of the second flow paths, the method comprising:
arranging the total heat exchange element with the air flowing through the first flow paths and the air having a higher water vapor pressure than the air in the first flow paths flowing through the second flow paths.
